(19) United States
(12) Patent Application Publication
(10) Pub. No.: US 2020/0097221 A1
(43) Pub. Date: Mar. 26, 2020

(54) CONTROL APPARATUS, CONTROL SYSTEM, AND NON-TRANSITORY COMPUTER READABLE MEDIUM

(71) Applicant: FUJI XEROX CO., LTD., Tokyo (JP)

(72) Inventors: Ryo MATSUMOTO, Kanagawa (JP); Kiyoshi YASUKAWA, Kanagawa (JP); Yohei MAKINO, Kanagawa (JP); Tsuyoshi TODA, Kanagawa (JP); Satoshi MARUYAMA, Kanagawa (JP); Takafumi HARUTA, Kanagawa (JP); Ryoto YABUSAKI, Kanagawa (JP); Yu MISHIMA, Kanagawa (JP)

(73) Assignee: FUJI XEROX CO., LTD., Tokyo (JP)

(21) Appl. No.: 16/569,976

(22) Filed: Sep. 13, 2019

(30) Foreign Application Priority Data
Sep. 25, 2018 (JP) 2018-179453

(51) Int. Cl. G06F 3/12; H04L 12/58

(52) U.S. Cl. CPC G06F 3/1204; G06F 3/1273; G06F 3/1253; H04L 51/046

(57) ABSTRACT

A control apparatus includes a receiving unit and a controller. The receiving unit receives an execution command for a predetermined process in a service. The service displays a post posted by a user in a chronological order in a predetermined direction and is usable for commanding execution of the process. The controller performs control to perform carousel-layout display such that, if the post corresponding to the execution command for the process received by the receiving unit includes multiple posts, the multiple posts and command information related to the execution command for the process corresponding to the multiple posts are displayed in the service in a slidably-operable manner in a direction intersecting the predetermined direction.

### CROSS-REFERENCE TO RELATED APPLICATIONS

This application is based on and claims priority under 35 USC 119 from Japanese Patent Application No. 2018-179453 filed Sep. 25, 2018.

### BACKGROUND

### (i) Technical Field

The present disclosure relates to control apparatuses, control systems, and non-transitory computer readable media.

### (ii) Related Art

Japanese Unexamined Patent Application Publication No. 2014-164522 discloses a message notification apparatus including an operation-command detector, an external-device controller, an operation-result acquiring unit, a report-message generator, and a report-message display unit. The operation-command detector detects an operation command for operating an external device from a message in a communication service that displays messages written by members in a time-series fashion, and also identifies the member who has written the message as a commander of the operation command. The external-device controller controls the external device in accordance with the operation command detected by the operation-command detector. The operation-result acquiring unit acquires an operation result of the external device operating under the control of the external-device controller. The report-message generator generates a report message reporting the operation result acquired by the operation-result acquiring unit. The report-message display unit outputs the report message generated by the report-message generator to a server that provides the communication service, and causes the communication service to display the message in a state where the commander identified by the operation-command detector is specified as a destination.

In a service that displays information posted by a user in a chronological order in a predetermined direction and that is usable for commanding execution of a predetermined process, when multiple pieces of information are posted and previously-posted information is to be traced back, it is necessary to trace back to the previously-posted information by the number of pieces of posted information, resulting in lower operability.

### SUMMARY

Aspects of non-limiting embodiments of the present disclosure relate to a control apparatus, a control system, and a non-transitory computer readable medium in which, in a service that displays information posted by a user in a chronological order in a predetermined direction and that is usable for commanding execution of a predetermined process, the operability for tracing back to previously-posted information may be improved, as compared with a case where the posted information is continuously displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a control apparatus including a receiving unit and a controller. The receiving unit receives an execution command for a predetermined process in a service. The service displays a post posted by a user in a chronological order in a predetermined direction and is usable for commanding execution of the process. The controller performs control to perform carousel-layout display such that, if the post corresponding to the execution command for the process received by the receiving unit includes multiple posts, the multiple posts and command information related to the execution command for the process corresponding to the multiple posts are displayed in the service in a slidably-operable manner in a direction intersecting the predetermined direction.

### BRIEF DESCRIPTION OF THE DRAWINGS

Exemplary embodiments of the present disclosure will be described in detail based on the following figures, wherein:

FIG. 1 schematically illustrates the configuration of a control system according to an exemplary embodiment;

FIG. 2 is a block diagram illustrating the hardware configuration of a chat room server;

FIG. 3 is a block diagram illustrating the hardware configuration of a chatbot server;

FIG. 4 is a block diagram illustrating an example of the functional configuration of the chat room server;

FIG. 5 is a block diagram illustrating an example of the functional configuration of the chatbot server;

FIG. 6 illustrates a state where multiple printing-related posts are received after a message is posted;

FIG. 7 is a flowchart illustrating an example of the flow of a process performed in the chatbot server according to a first exemplary embodiment;

FIG. 8 is a flowchart illustrating an example of the flow of a public printing process performed in the chatbot server according to the first exemplary embodiment;

FIG. 9 is a diagram for explaining the public printing process;

FIG. 10 is a flowchart illustrating an example of the flow of a private printing process performed in the chatbot server according to the first exemplary embodiment;

FIG. 11 is a diagram for explaining the private printing process;

FIG. 12 is a flowchart illustrating an example of the flow of a process performed in the chatbot server according to a second exemplary embodiment;

FIG. 13 is a diagram for explaining the process performed in the chatbot server according to the second exemplary embodiment;

FIG. 14 is a diagram for explaining a print setting process included in the process performed in the chatbot server according to the second exemplary embodiment;

FIG. 15 is a flowchart illustrating an example of the flow of a process performed in the chatbot server according to a third exemplary embodiment; and

FIG. 16 is a diagram for explaining the process performed in the chatbot server according to the third exemplary embodiment.

### DETAILED DESCRIPTION

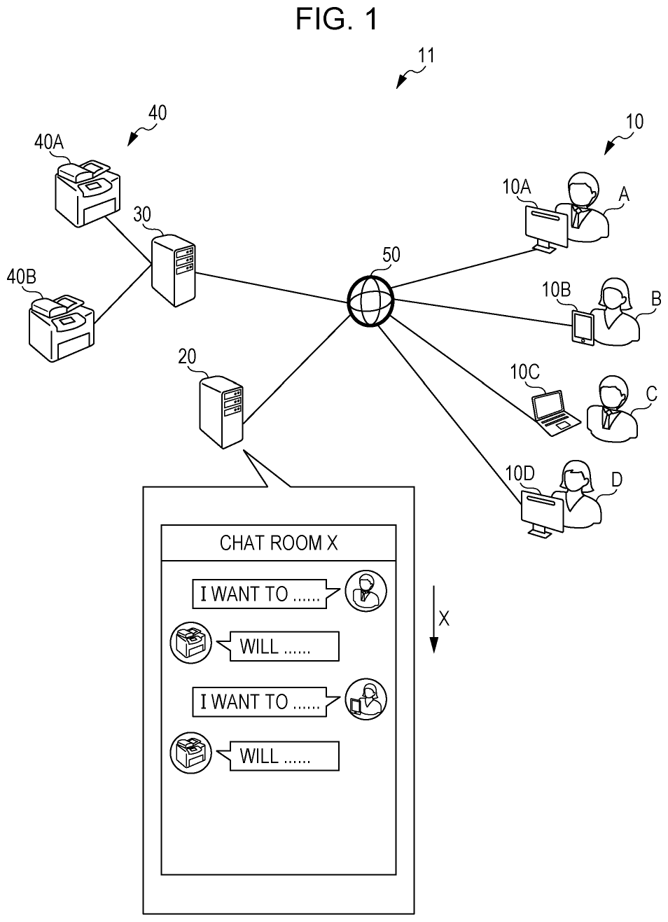

Exemplary embodiments of the present disclosure will be described in detail below with reference to the drawings. In the drawings, identical or equivalent components and sections are given the same reference signs. Furthermore, the dimensional ratios in the drawings are exaggerated for the sake of convenience and may sometimes differ from the actual ratios. FIG. 1 schematically illustrates the configuration of a control system 11 according to an exemplary embodiment.

A control system 11 includes user terminals 10 as terminal apparatuses, a chat room server 20 as a providing apparatus, a chatbot server 30 as a control apparatus, and information processing apparatuses 40. The user terminals 10, the chat room server 20, and the chatbot server 30 are connected to one another by the Internet 50.

The user terminals 10 are terminals used by users and may be any type of terminals, such as desktop computers, notebook personal computers, tablets, and smartphones. In FIG. 1, it is assumed that a user A uses a user terminal 10A, a user B uses a user terminal 10B, a user C uses a user terminal 10C, and a user D uses a user terminal 10D. The user terminals 10A to 10D will collectively be referred to as “user terminals 10”.

The chat room server 20 provides a chat room as a service. A chat room is a virtual space in which a user and a chatbot, to be described later, may participate and share data, such as a message and an image, as a chat. A chat is a conversation held by multiple members posting information in real time in a computer network. The term “members” includes both a user associated with a real-life person and a software robot operating in accordance with a specific rule. A chatbot is a software robot that performs control such that a specific process is executed based on a post posted in the chat room by a user. Multiple users or a single user may participate in the chat room.

A user is capable of posting a message or outputting speech in the chat room via the user terminal 10 of the user. In the chat room, users may share a message, and the chatbot may respond and reply to a user's message. Furthermore, in the chat room, a user may give a command to the chatbot so as to cause a corresponding one of the information processing apparatuses 40 to execute a specific process. For example, the chatbot performs control to extract a command included in a message by natural language processing and to cause the information processing apparatus 40 to execute a specific process. A single user and the chatbot may participate in the chat room in a one-to-one fashion, or multiple users and the chatbot may participate in the chat room. The number of chat rooms may be a plural value equal in number to opened chat rooms.

The chatbot server 30 manages the chatbot. As mentioned above, the chatbot participates in the chat room and responds to a user's message or causes the information processing apparatus 40 to execute a specific process in accordance with a command included in the message.

When the message related to the command for causing the information processing apparatus 40 to execute the specific process is posted in the chat room that the chatbot is participating in, the chatbot causes the information processing apparatus 40 registered in association with the users participating in the chat room to execute the specific process. The information processing apparatus 40 may perform any type of information processing. The term “information processing” includes, for example, a process for executing printing based on text data or image data, a process for generating or processing data by using equipment included in the information processing apparatus 40, and a process for exchanging data between the information processing apparatus 40 and another apparatus. The following description relates to an example where the information processing apparatus 40 is an image forming apparatus, and the command for executing the specific process is a command for causing the image forming apparatus to execute printing. In the following description, reference sign 40 is given to the image forming apparatus. The command for causing the image forming apparatus 40 to execute printing not only includes a direct printing command given to the image forming apparatus 40, but may also include information used for generating a print job, such as providing image data to be printed or print specifications in the chat room.

The image forming apparatus 40 forms an image on a recording medium, such as a sheet, based on a print job and may be any type of apparatus, such as a printer or a multifunction apparatus. In the example of the control system 11 shown in FIG. 1, an image forming apparatus 40A and an image forming apparatus 40B are managed by the chatbot server 30. The image forming apparatus 40A and the image forming apparatus 40B will collectively be referred to as “image forming apparatuses 40”. Although the image forming apparatuses 40 are connected to the chatbot server 30 in the example shown in FIG. 1, the image forming apparatuses 40 may alternatively be connected to the chatbot server 30 via the Internet 50.

Next, the hardware configurations of the chat room server 20 and the chatbot server 30 will be described.

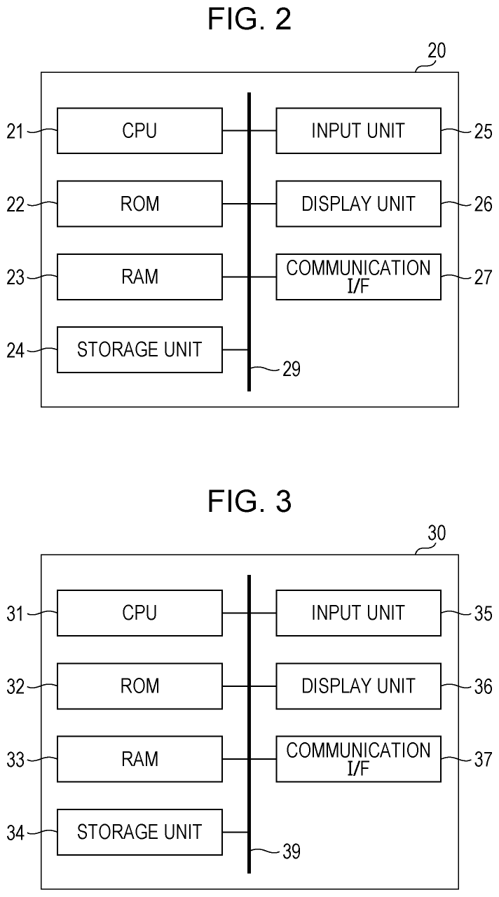

First, the hardware configuration of the chat room server 20 will be described. FIG. 2 is a block diagram illustrating the hardware configuration of the chat room server 20.

As shown in FIG. 2, the chat room server 20 includes components, such as a central processing unit (CPU) 21, a read-only memory (ROM) 22, a random access memory (RAM) 23, a storage unit 24, an input unit 25, a display unit 26, and a communication interface (I/F) 27. These components are connected to one another in a communicable manner via a bus 29.

The CPU 21 is a central processing unit executing various types of programs and controlling each unit. Specifically, the CPU 21 loads a program from the ROM 22 or the storage unit 24 and executes the program by using the RAM 23 as a work area. The CPU 21 controls each of the aforementioned components and performs various types of arithmetic processing in accordance with programs stored in the ROM 22 or the storage unit 24. In this exemplary embodiment, the ROM 22 or the storage unit 24 stores a chat-room providing program that provides the chat room.

The ROM 22 stores various types of programs and various types of data. The RAM 23 serves as a work area that temporarily stores a program or data. The storage unit 24 is constituted of a hard disk drive (HDD) or a solid state drive (SSD) and stores various types of programs including the operating system, as well as various types of data.

The input unit 25 includes a pointing device, such as a mouse, and a keyboard, and is used for performing various types of input operations. The display unit 26 is, for example, a liquid crystal display and displays various types of information. The display unit 26 may be of a touchscreen type so as to also function as the input unit 25. The communication I/F 27 communicates with another apparatus via the Internet 50. For example, the standard used with respect to the communication I/F 27 may be Ethernet (registered trademark), fiber distributed data interface (FDDI), or Wi-Fi (registered trademark).

Next, the hardware configuration of the chatbot server 30 will be described. FIG. 3 is a block diagram illustrating the hardware configuration of the chatbot server 30.

As shown in FIG. 3, the chatbot server 30 includes components, such as a CPU 31, a ROM 32, a RAM 33, a storage unit 34, an input unit 35, a display unit 36, and a communication I/F 37. These components are connected to one another in a communicable manner via a bus 39. The components of the chatbot server 30 have functions similar to those of the components of the chat room server 20 in FIG. 2.

Next, the functional configurations of the chat room server 20 and the chatbot server 30 will be described.

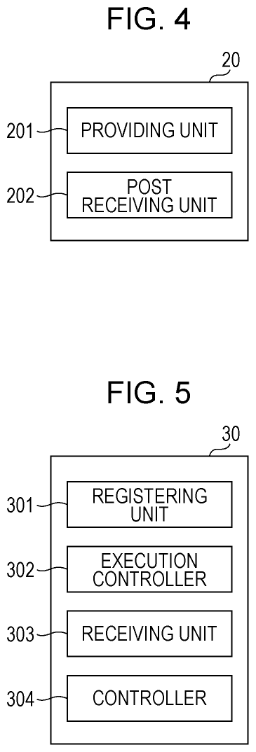

First, the functional configuration of the chat room server 20 will be described. FIG. 4 is a block diagram illustrating an example of the functional configuration of the chat room server 20.

As shown in FIG. 4, the chat room server 20 has a providing unit 201 and a post receiving unit 202 as functional components. These functional components are realized by the CPU 21 loading the chat-room providing program stored in the ROM 22 or the storage unit 24 and developing and executing the chat-room providing program in the RAM 23.

The providing unit 201 provides, as a service, a chat room in which multiple users may participate and post messages. The chat room server 20 provides a chat room in which a single user and the chatbot may participate in a one-to-one fashion, and also provides a chat room in which multiple users and the chatbot may participate. Multiple chat rooms may be opened in accordance with an open request from a user. Furthermore, for example, if a certain user makes a chat-room open request by accessing the chat room server 20 and opens a specific chat room, the user who is the chat-room opener may invite another user to participate in the opened chat room. Alternatively, a user who is already participating in a chat room may invite another user not participating in the chat room to newly participate in the chat room.

The post receiving unit 202 receives information input via a user terminal 10 operated by a user participating in the chat room and posts the input information in the chat room provided by the providing unit 201. The posts in the chat room are displayed on the user terminal 10 in a chronological order in a predetermined direction. In this exemplary embodiment, the posts are displayed in a chronological order from top to bottom on a screen on which the chat room is displayed, as indicated by an arrow X in FIG. 1.

Next, the functional configuration of the chatbot server 30 will be described. FIG. 5 is a block diagram illustrating an example of the functional configuration of the chatbot server 30.

As shown in FIG. 5, the chatbot server 30 has, as functional components, a registering unit 301, an execution controller 302, a receiving unit 303, and a controller 304. These functional components are realized by the CPU 31 loading a control program stored in the ROM 32 or the storage unit 34 and developing and executing the control program in the RAM 33.

The registering unit 301 registers a user and an image forming apparatus 40 in association with each other. By registering an image forming apparatus 40 with a user, printing using the image forming apparatus 40 is performed in response to a request from the user.

The execution controller 302 participates as a chatbot in the chat room and controls a conversation with a user participating in the chat room. If a command for causing an image forming apparatus (information processing apparatus) 40 to execute printing is received in the chat room, or if a command message related to the command is posted in the chat room by the user, the execution controller 302 performs control to cause one of the image forming apparatuses 40 associated with the user participating in the chat room to execute printing. Even if a command message is posted in the chat room by a user with which none of the image forming apparatuses 40 is associated, the execution controller 302 still performs control to cause one of the image forming apparatuses 40 to execute printing.

The receiving unit 303 receives, as a print command, a reply made to an inquiry posted in the chat room by the chatbot for printing an image posted in the chat room via a user terminal 10. Alternatively, the receiving unit 303 receives a command for printing using an image forming apparatus 40 from a post posted in the chat room from the user terminal 10.

If there are multiple posts corresponding to the print command received by the receiving unit 303, the controller 304 performs control such that the multiple posts and command information related to the print command corresponding to the multiple posts are displayed in a carousel-layout fashion in the chat room in a slidably-operable manner in a direction intersecting a predetermined direction.

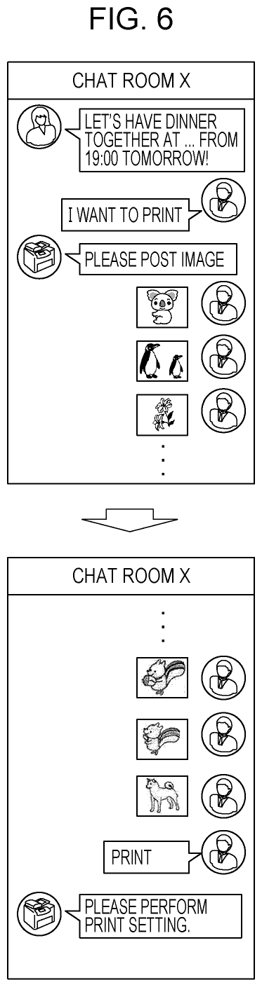

For example, as shown in FIG. 6, when a message “Let's have dinner together at . . . from 19:00 tomorrow!” is posted, if multiple printing-related posts corresponding to a print command are subsequently posted, past messages are no longer displayed, as shown in the lower part of FIG. 6. The operability for tracing back to a past message deteriorates with increasing number of printing-related posts. The controller 304 performs carousel-layout display to reduce the tracing amount, thereby achieving improved operability.

In this exemplary embodiment, carousel-layout display involves displaying information in a slidably-operable manner in a direction intersecting the direction for displaying information, such as messages, in the chat room in a chronological order in the predetermined direction. The direction intersecting the direction for displaying information, such as messages, in a chronological order in the predetermined direction may sometimes be referred to as a direction intersecting a scrolling direction of the chat room.

The following description relates to a specific process performed in the chatbot server 30 of the control system 11 having the above-described configuration.

### First Exemplary Embodiment

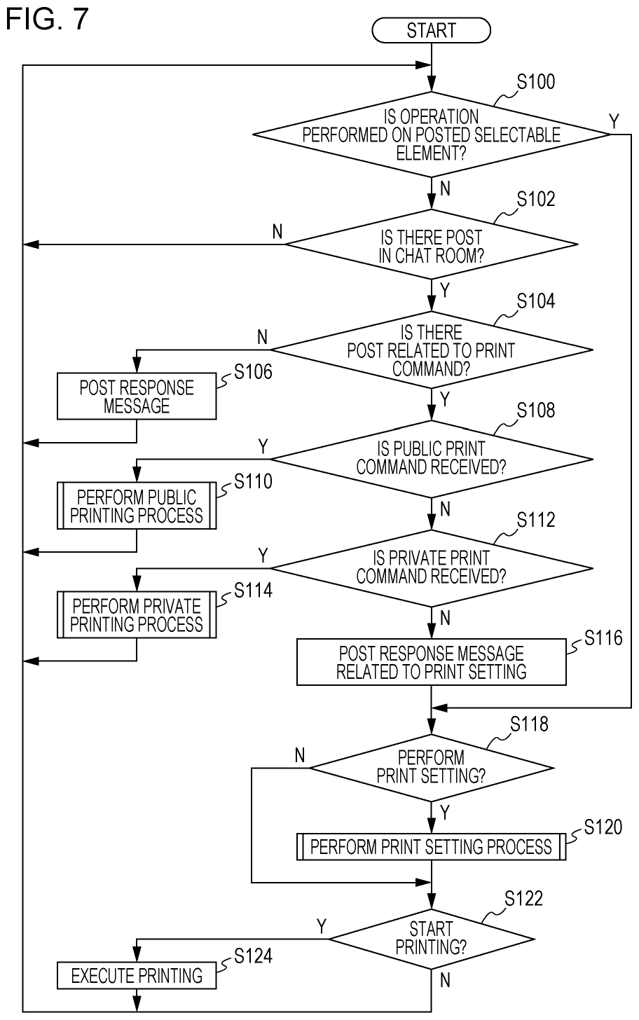

In a first exemplary embodiment, an album is shareable within a group chat shared by multiple users, and information about each user is also storable. This exemplary embodiment relates to a process performed in the chatbot server 30 that allows for printing of the album (public printing) and printing of information stored by each user (private printing). FIG. 7 is a flowchart illustrating an example of the flow of the process performed in the chatbot server 30 according to this exemplary embodiment. For example, the process in FIG. 7 starts when the user accesses the chat room from the user terminal 10 and ends when the user exits the chat room.

In step S100, the receiving unit 303 determines whether or not an operation performed on a posted selectable element is received. For example, this determination process involves determining whether or not an operation corresponding to a selectable element as command information related to a print execution command, such as a selectable element “print setting” or “start printing”, having undergone a process to be described below and posted in the chat room, is received. If a positive determination result is obtained, the process proceeds to step S118 to be described below. If a negative determination result is obtained, the process proceeds to step S102.

In step S102, the execution controller 302 determines whether or not, for example, a message is posted in the chat room by the user. If a negative determination result indicating that there is no post in the chat room is obtained, the process returns to step S100 to repeat the above-described process. If a positive determination result is obtained, the process proceeds to step S104.

In step S104, the execution controller 302 determines whether or not the post in the chat room is a command message related to a print command. This determination process involves, for example, performing natural language processing on the posted message and determining that the post is related to a print command if the posted message includes a term related to “print” or “print setting”. For example, a positive determination result is obtained when a message, such as “I want to print”, “public printing”, or “private printing”, is posted as a message. If a negative determination result is obtained, the process proceeds to step S106. If a positive determination result is obtained, the process proceeds to step S108.

In step S106, the execution controller 302 posts a response message in the chat room that corresponds to the message posted in the chat room. The process then returns to step S100 to repeat the above-described process. For example, if a message asking about the weather is posted, the CPU 31 acting as the chatbot acquires information about the weather from the Internet and posts a weather-related reply message in the chat room. Accordingly, a conversation between the user and the chatbot is established in the chat room.

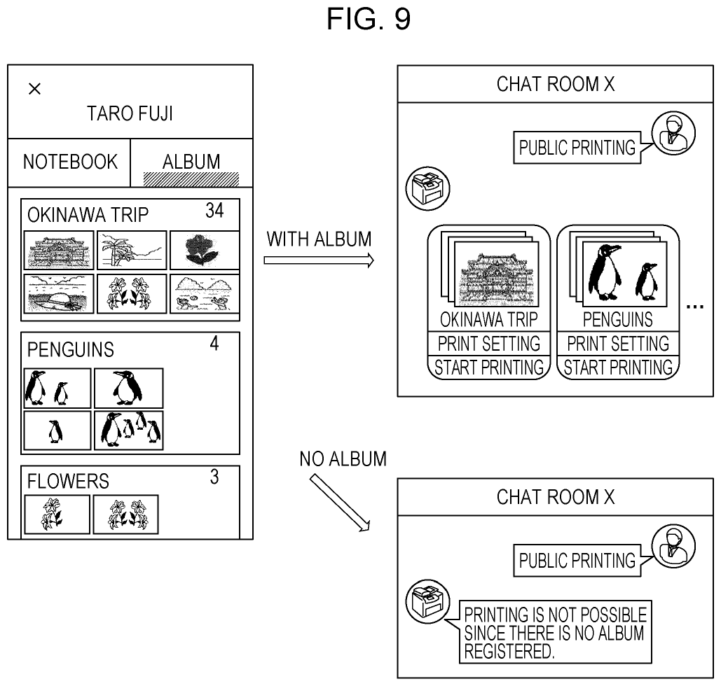

In step S108, the receiving unit 303 determines whether or not a public print command is received. This determination process involves, for example, determining whether or not a message “public printing” is posted, as shown in FIG. 9. If a positive determination result is obtained, the process proceeds to step S110. If a negative determination result is obtained, the process proceeds to step S112.

In step S110, the execution controller 302 executes a public printing process for printing the images in the album. The process then returns to step S100 to repeat the above-described process. The public printing process will be described in detail later.

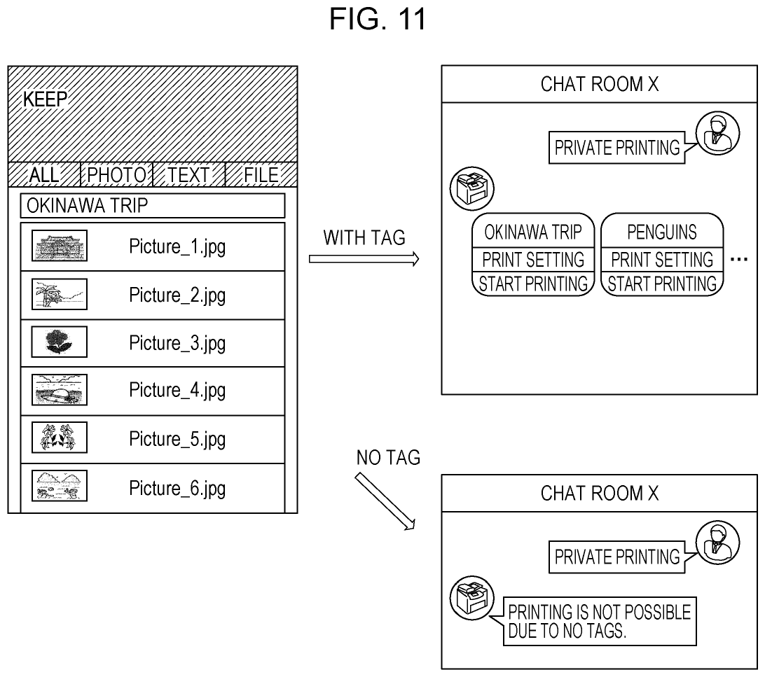

In step S112, the receiving unit 303 determines whether or not a private print command is received. For example, as shown in FIG. 11, this determination process involves determining whether or not a message “private printing” is posted. If a positive determination result is obtained, the process proceeds to step S114. If a negative determination result is obtained, the process proceeds to step S116.

In step S114, the execution controller 302 performs a private printing process for printing an image stored by each user. The process then returns to step S100 to repeat the above-described process. The private printing process will be described in detail later.

In step S116, the execution controller 302 posts a response message related to print setting in the chat room, and the process then proceeds to step S118. For example, a message “perform print setting?” is posted in the chat room as the response message related to print setting.

In step S118, the receiving unit 303 determines whether or not an operation or post related to print setting is received, thereby determining whether or not print setting is to be performed. If a positive determination result is obtained, the process proceeds to step S120. If a negative determination result is obtained, the process proceeds to step S122.

In step S120, the execution controller 302 performs a print setting process, and the process then proceeds to step S122. The print setting process involves, for example, performing print setting by having a print-setting-related conversation in the chat room.

In step S122, the execution controller 302 determines whether or not to start printing. For example, this determination process involves determining whether or not the print setting is completed as a result of the print setting process in step S120. If a positive determination result is obtained, the process proceeds to step S124. If a negative determination result is obtained, the process returns to step S100 to repeat the above-described process.

In step S124, the execution controller 302 causes the image forming apparatus 40 preregistered by the registering unit 301 to execute printing. The process then returns to step S100 to repeat the above-described process.

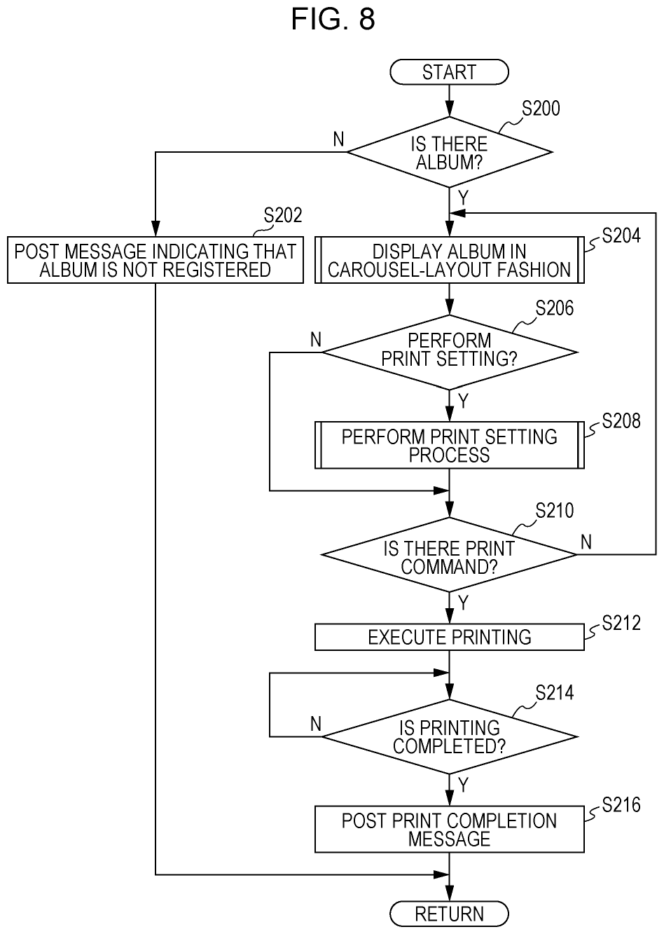

Next, the aforementioned public printing process will be described in detail. FIG. 8 is a flowchart illustrating an example of the flow of the public printing process performed in the chatbot server 30 according to this exemplary embodiment.

In step S200, the execution controller 302 determines whether or not there is an album shared within the group chat. If a negative determination result is obtained, the process proceeds to step S202. If a positive determination result is obtained, the process proceeds to step S204.

In step S202, the execution controller 302 posts, in the chat room, a message indicating that an album is not registered. The process then returns to step S100 described above. For example, as shown in FIG. 9, if there is no album, a message “printing is not possible since there is no album registered” is posted in the chat room.

In step S204, the controller 304 performs a process for displaying the album information in a carousel-layout fashion. The process then proceeds to step S206. Specifically, the process of carousel-layout display involves displaying images within the registered album in a scrollable (slidably-operable) manner in the direction intersecting the scrolling direction of the chat room, as shown in FIG. 9. FIG. 9 illustrates an example where images associated with “Okinawa Trip” in the album are displayed in a compilation-layout fashion and images associated with “Penguins” are displayed in a compilation-layout fashion, and also illustrates images associated with “Flowers” in the album that are displayable in a compilation-layout fashion by being scrolled rightward in FIG. 9. The compilation-layout display in FIG. 9 includes a selectable element “print setting” and a selectable element “start printing”. Accordingly, this may reduce the tracing amount in carousel-layout display when tracing back to a past post, as compared with a case where all of the images in the album are posted and displayed in the chat room, thereby achieving improved operability. If the receiving unit 303 receives an operation performed on the selectable element “print setting” or “start printing” in FIG. 9, a print setting process or a print starting process is performed.

In step S206, the receiving unit 303 determines whether or not a print-setting-related operation is received, thereby determining whether or not print setting is to be performed. For example, the receiving unit 303 determines whether or not the selectable element “print setting” is operated in the compilation-layout display in FIG. 9. If a positive determination result is obtained, the process proceeds to step S208. If a negative determination result is obtained, the process proceeds to step S210.

In step S208, the execution controller 302 performs a print setting process. The process then proceeds to step S210. The print setting process involves, for example, displaying a print setting item and allowing the user to select the print setting item.

In step S210, the receiving unit 303 determines whether or not a print-command-related operation is received, thereby determining whether or not printing is to be started. For example, the receiving unit 303 determines whether or not the selectable element “start printing” is operated in the compilation-layout display in FIG. 9. If a negative determination result is obtained, the process returns to step S204 where carousel-layout display is performed and the carousel-layout display is scrolled. If a positive determination result is obtained, the process proceeds to step S212. While steps S204 to S210 are being repeated, a corresponding process is performed when a message posted in the chat room is scrolled or when a message is posted.

In step S212, the execution controller 302 causes the image forming apparatus 40 preregistered by the registering unit 301 to execute printing. The process then proceeds to step S214.

In step S214, the execution controller 302 determines whether or not the printing is completed. This determination process involves causing the image forming apparatus 40 to execute printing and determining whether or not the printing is completed. The execution controller 302 waits until a positive determination result is obtained, and the process then proceeds to step S216.

In step S216, the execution controller 302 posts a print completion message in the chat room. The process then returns to step S100 to repeat the above-described process.

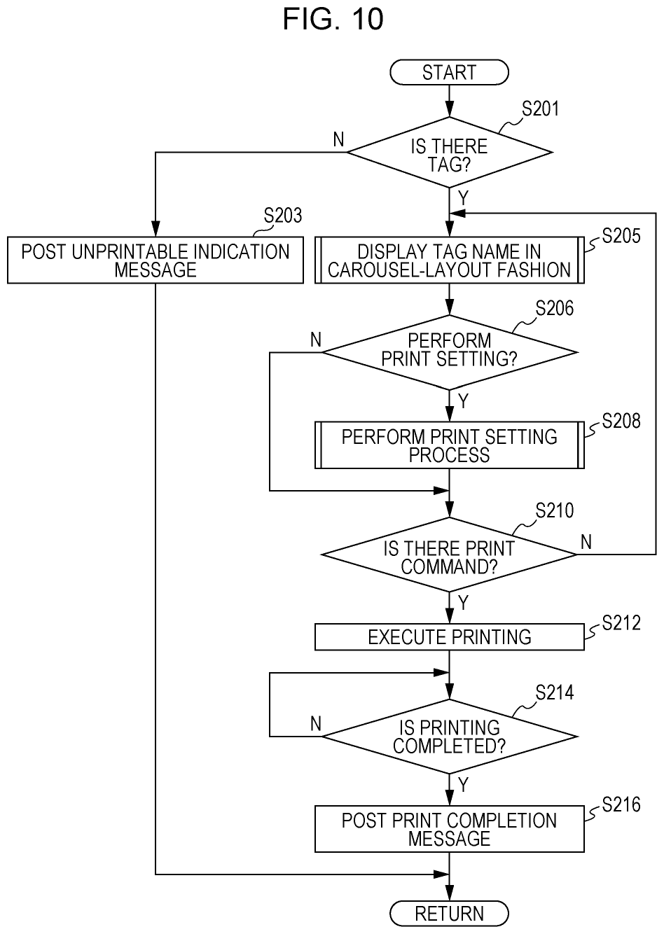

Next, the aforementioned private printing process will be described in detail. FIG. 10 is a flowchart illustrating an example of the flow of the private printing process performed in the chatbot server 30 according to this exemplary embodiment. Steps identical to those in the public printing process in FIG. 8 are given the same reference signs, and detailed descriptions thereof are omitted.

In step S201, the execution controller 302 determines whether or not there is a tag as marker information within a folder (such as a folder “KEEP” in FIG. 11) stored as information about each user. This determination process involves determining whether or not there is a tag, such as “Okinawa Trip” or “Penguins”, in the folder “KEEP” shown in FIG. 11. If a negative determination result is obtained, the process proceeds to step S203. If a positive determination result is obtained, the process proceeds to step S205.

In step S203, the execution controller 302 posts an unprintable indication message in the chat room, and the process then returns to step S100. For example, as shown in FIG. 11, if there is no tag in the folder “KEEP”, a message “printing is not possible due to no tags” is posted in the chat room.

In step S205, the controller 304 performs a process for displaying a tag name or tag names in a carousel-layout fashion. The process then proceeds to step S206. Subsequently, steps similar to those in the album printing process are performed. Specifically, because the folder “KEEP” contains personal information, the carousel-layout display process does not involve displaying images, unlike the album, but involves displaying a tag name or tag names in a scrollable (slidably-operable) manner in the direction intersecting the scrolling direction of the chat room, as shown in FIG. 11. FIG. 11 illustrates an example where “Okinawa Trip” and “Penguins” as tag names of the folder “KEEP” are displayed together with the selectable element “print setting” and the selectable element “start printing”. If there is another tag name, the tag name is displayed by being scrolled rightward in FIG. 11. Accordingly, this may reduce the tracing amount in carousel-layout display when tracing back to a past post, as compared with a case where all of the tag names in the folder “KEEP” are posted and displayed in the chat room, thereby achieving improved operability. If the receiving unit 303 receives an operation performed on the selectable element “print setting” or “start printing” in FIG. 11, a print setting process or a print starting process is performed.

Although the album printing process and the private printing process are both performable in this exemplary embodiment, only one of the two processes may be performed.

### Second Exemplary Embodiment

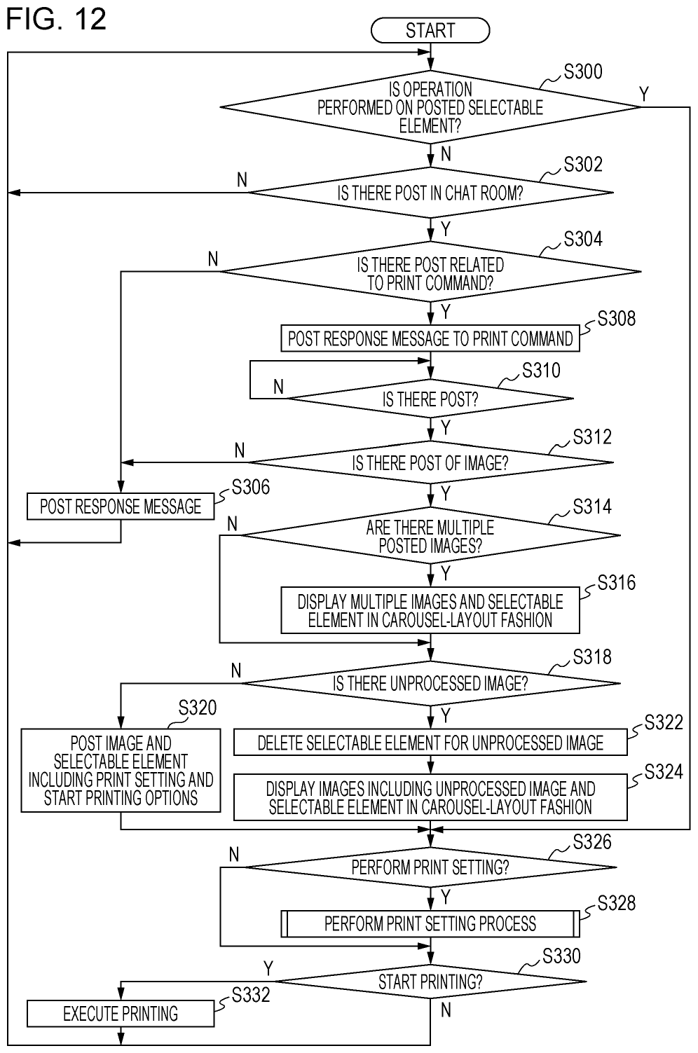

When the album printing process or the private printing process is to be performed in the first exemplary embodiment, an image to be printed and information (tag) are displayed in a carousel-layout fashion together with one or more selectable elements. This exemplary embodiment relates to an example where carousel-layout display is performed when there are multiple images to be printed. In detail, when a second image to be printed and onward are posted, the posted images are displayed in a carousel-layout fashion. FIG. 12 is a flowchart illustrating an example of the flow of a process performed in the chatbot server 30 according to this exemplary embodiment. For example, the process in FIG. 12 starts when the user accesses the chat room from the user terminal 10 and ends when the user exits the chat room.

In step S300, the receiving unit 303 determines whether or not an operation performed on a posted selectable element is received. This determination process involves, for example, determining whether or not an operation corresponding to a printing-related selectable element, such as a selectable element “print setting” or a selectable element “start printing”, having undergone a process to be described below and posted in the chat room, is received. If a positive determination result is obtained, the process proceeds to step S326 to be described below. If a negative determination result is obtained, the process proceeds to step S302.

In step S302, the execution controller 302 determines whether or not there is a post, such as a message, posted in the chat room by the user. If there is no post in the chat room and a negative determination result is obtained, the process returns to step S300 to repeat the above-described process. If a positive determination result is obtained, the process proceeds to step S304.

In step S304, the execution controller 302 determines whether or not the post in the chat room is a command message related to a print command. This determination process involves, for example, performing natural language processing on the posted message and determining that the post is related to a print command if the posted message includes a term related to “print” or “print setting”. For example, a positive determination result is obtained when a message “I want to print” is posted. If a negative determination result is obtained, the process proceeds to step S306. If a positive determination result is obtained, the process proceeds to step S308.

In step S306, the execution controller 302 posts, in the chat room, a response message to the message posted in the chat room. The process then returns to step S300 to repeat the above-described process. For example, if a message asking about the weather is posted, the CPU 31 acting as the chatbot acquires information about the weather from the Internet and posts a weather-related reply message in the chat room. Accordingly, a conversation between the user and the chatbot is established in the chat room.

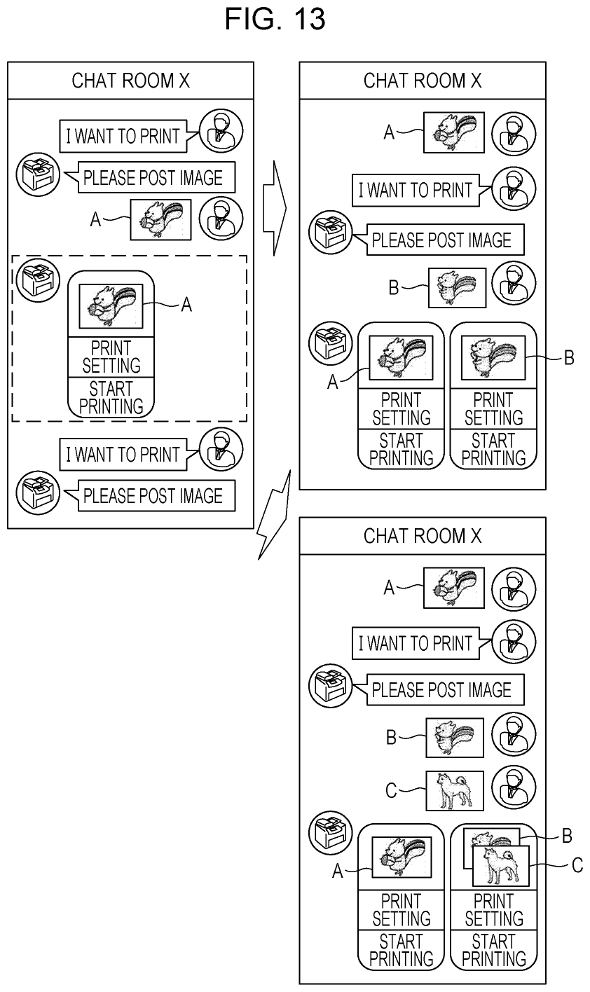

In step S308, the execution controller 302 posts, in the chat room, a response message to the message related to the print command posted in the chat room, and the process then proceeds to step S310. For example, as shown in FIG. 13, a message “please post image” is posted in the chat room as the response message to the message related to the print command.

In step S310, the execution controller 302 determines whether or not there is a post in the chat room. The execution controller 302 waits until a positive determination result is obtained, and the process then proceeds to step S312.

In step S312, the execution controller 302 determines whether or not the post in the chat room is a post of an image to be printed. If a message is posted instead of an image, a negative determination result is obtained. The process then proceeds to step S306 described above. If a positive determination result is obtained, the process proceeds to step S314.

In step S314, the execution controller 302 determines whether or not the posted image to be printed includes multiple images. If a positive determination result is obtained, the process proceeds to step S316. If a negative determination result is obtained, the process proceeds to step S318.

In step S316, the controller 304 displays the multiple received images and a selectable element corresponding to each image in a carousel-layout fashion. The process then proceeds to step S318. For example, as shown in the lower right part of FIG. 13, if multiple images are successively posted, the posted images and the selectable elements “print setting” and “start printing” are displayed in a carousel-layout fashion. Since there are two selectable elements displayed in the example in FIG. 13, there is no horizontal scroll bar in FIG. 13. If there are three or more selectable elements, a horizontal scroll bar is displayed in FIG. 13. Alternatively, if two selectable elements are not simultaneously displayable on the screen, the non-displayed image is displayed by using a scroll bar. Performing the carousel-layout display in this manner may reduce the tracing amount in the carousel-layout display when tracing back to a past post, as compared with a case where all of the multiple images and the printing-related selectable elements for each image are posted and displayed in the chat room, thereby achieving improved operability.

In step S318, the execution controller 302 determines whether or not there is an unprocessed image in the chat room that has not undergone printing. This determination process involves determining whether or not there is an unprocessed image not having undergone printing among the images posted in the chat room in the past. If a negative determination result is obtained, the process proceeds to step S320. If a positive determination result is obtained, the process proceeds to step S322.

In step S320, the execution controller 302 posts the posted image and the selectable elements “print setting” and “start printing”. The process then proceeds to step S326. For example, as indicated by a dotted line in the left part of FIG. 13, selectable elements for designating either one of the options “print setting” and “start printing” for the posted image are displayed together with the image.

In step S322, the controller 304 deletes the selectable elements for the unprocessed image not having undergone printing, and the process then proceeds to step S324. For example, as shown in the upper right part of FIG. 13, if an image A is posted and a subsequent image B is posted while the image A has not undergone printing and remains unprocessed, the selectable elements posted for the image A and indicated by the dotted line in the left part of FIG. 13 are deleted.

In step S324, the controller 304 displays the images including the unprocessed image not having undergone printing, as well as the selectable elements “print setting” and “start printing”, in a carousel-layout fashion. The process then proceeds to step S326. For example, as shown in the upper right part of FIG. 13, the selectable elements “print setting” and “start printing” for the image A and the selectable elements “print setting” and “start printing” for the image B are displayed in a carousel-layout fashion. Alternatively, as shown in the lower right part of FIG. 13, if images B and C are successively posted in a state where the unprocessed image A not having undergone printing still exists, the selectable element “print setting” and “start printing” for the unprocessed image A and the selectable elements “print setting” and “start printing” for the images B and C are displayed in a carousel-layout fashion. Since two selectable elements are displayed together in the example shown in FIG. 13, there is no horizontal scroll bar in FIG. 13. However, if there are three or more selectable elements, the three or more selectable elements are displayed by using a horizontal scroll bar in FIG. 13. Alternatively, if two selectable elements are not simultaneously displayable on the screen, the non-displayed image is displayed by using a scroll bar. Performing the carousel-layout display in this manner may reduce the tracing amount in the carousel-layout display when tracing back to a past post, as compared with a case where all of the multiple images and the printing-related selectable elements for each image are posted and displayed in the chat room, thereby achieving improved operability.

In step S326, the receiving unit 303 determines whether or not an operation related to the selectable element “print setting” is received, thereby determining whether or not print setting is to be performed. If a positive determination result is obtained, the process proceeds to step S328. If a negative determination result is obtained, the process proceeds to step S330.

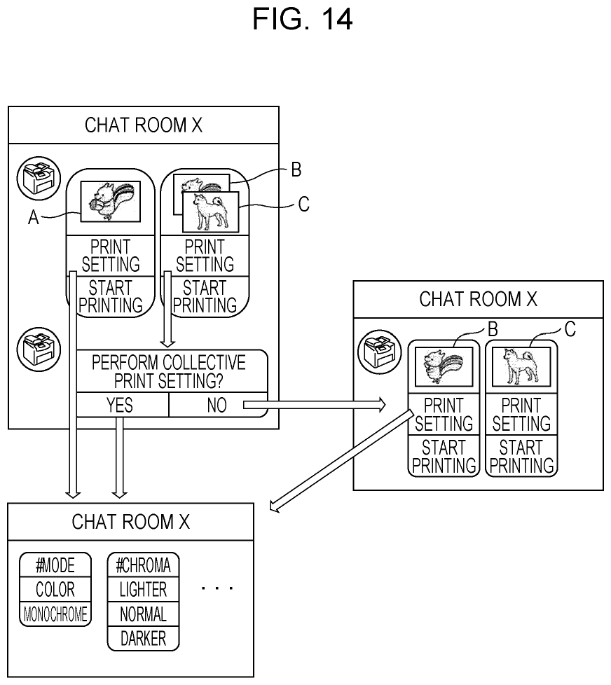

In step S328, the execution controller 302 performs a print setting process, and the process then proceeds to step S330. The print setting process involves, for example, displaying a print setting item and allowing the user to select the print setting item. For example, a print setting item for an image corresponding to an operated selectable element “print setting” is displayed and is selected by the user. For example, as shown in the lower part of FIG. 14, items, such as “# mode” and “# chroma”, are displayed as print setting items and are selected by the user. As shown in the left part of FIG. 14, in a case where the selectable elements “print setting” and “start printing” for the unprocessed image A and the selectable elements “print setting” and “start printing” for the images B and C are displayed in a carousel-layout fashion, if an operation performed on the selectable element “print setting” for the image A is received, the print settings for the image A are displayed, and the user is caused to perform a selection process, as shown in the lower part of FIG. 14. If an operation performed on the selectable element “print setting” for the images B and C is received, a message “perform collective print setting?” may be displayed, as shown in the upper left part of FIG. 14, and selectable elements “Yes” and “No” may be displayed and be selected by the user. In this case, if an operation performed on the selectable element “Yes” is received by the receiving unit 303, the print settings are displayed and are collectively set by the user, as shown in the lower left part of FIG. 14. If an operation performed on the selectable element “No” is received by the receiving unit 303, the selectable elements “print setting” and “start printing” for each image may be displayed in a carousel-layout fashion, as shown in the right part of the FIG. 14, and may be selected by the user.

In step S330, the receiving unit 303 determines whether or not an operation related to the selectable element “start printing” is received, thereby determining whether or not printing is to be started. For example, as shown in FIG. 13, the receiving unit 303 determines whether or not the selectable element “start printing” is operated. If a negative determination result is obtained, the process returns to step S300 to repeat the above-described process. If a positive determination result is obtained, the process proceeds to step S332.

In step S332, the execution controller 302 causes the image forming apparatus 40 preregistered by the registering unit 301 to execute printing of the image corresponding to the selectable element designated in step S330. The process then returns to step S300 to repeat the above-described process.

### Third Exemplary Embodiment

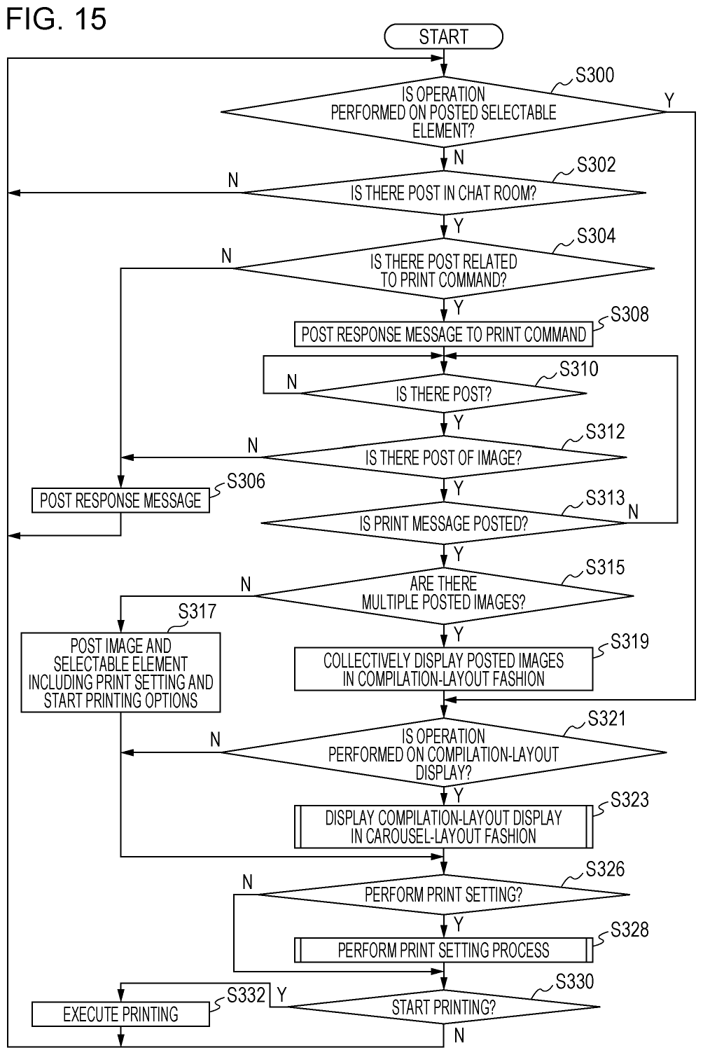

Similar to the second exemplary embodiment, a third exemplary embodiment relates to an example where carousel-layout display is performed when there are multiple images to be printed. In detail, as in the second exemplary embodiment, before the multiple images to be printed and the selectable elements for the multiple images are to be displayed in a carousel-layout fashion, the controller 304 according to this exemplary embodiment collectively displays the multiple posts and the selectable elements as predetermined compilation information. Then, when there is an operation performed on the compilation information, the controller 304 performs control to display the multiple images and the selectable elements compiled in the compilation information in a carousel-layout fashion. FIG. 15 is a flowchart illustrating an example of the flow of a process performed in the chatbot server 30 according to this exemplary embodiment. For example, the process in FIG. 15 starts when the user accesses the chat room from the user terminal 10 and ends when the user exits the chat room. Detailed descriptions of steps identical to those in the process shown in FIG. 12 are omitted.

Specifically, steps S300 to S312 are performed similarly to the above-described exemplary embodiments. When a positive determination result is obtained in step S312, the process proceeds to step S313.

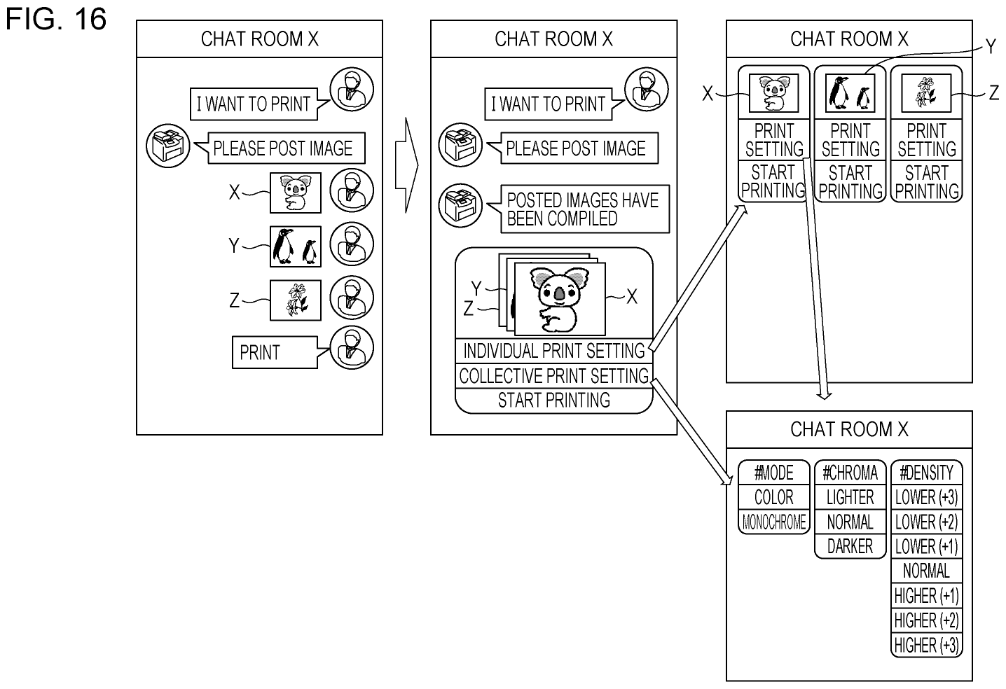

In step S313, the execution controller 302 determines whether or not a print message is posted. For example, as shown in the left part of FIG. 16, this determination process involves determining whether or not a message “print” is posted. If a negative determination result is obtained, the process returns to step S310 to repeat the above-described process. If a positive determination result is obtained, the process proceeds to step S315.

In step S315, the execution controller 302 determines whether or not there are multiple posted images. If a negative determination result is obtained, the process proceeds to step S317. If a positive determination result is obtained, the process proceeds to step S319.

In step S317, the execution controller 302 posts the posted image and the selectable elements “print setting” and “start printing”. The process then proceeds to step S326. For example, similar to the dotted line in the left part of FIG. 13, selectable elements for designating either one of the options “print setting” and “start printing” for the posted image are displayed together with the image.

In step S319, the controller 304 collectively displays the posted images in a compilation-layout fashion. The process then proceeds to step S321. For example, as shown in the left part of FIG. 16, when the message “print” is posted after the multiple images are posted, the multiple images are collectively displayed in a compilation-layout fashion, as shown in the middle of FIG. 16. In the example shown in FIG. 16, images X to Z are collectively displayed in a compilation-layout fashion. Moreover, as shown in FIG. 16, the compilation-layout display includes selectable elements “individual print setting”, “collective print setting”, and “start printing”. Displaying the multiple images in a compilation-layout fashion in this manner may reduce the tracing amount in the compilation-layout display when tracing back to a past post, as compared with a case where all of the multiple images and the printing-related selectable elements for each image are posted and displayed in the chat room, thereby achieving improved operability.

In step S321, the receiving unit 303 determines whether or not an operation performed on the compilation-layout display is received. In this exemplary embodiment, it is determined whether or not an operation performed on the selectable element “individual print setting” displayed in a compilation-layout fashion is operated. If a positive determination result is obtained, the process proceeds to step S323. If a negative determination result is obtained, the process proceeds to step S326. The subsequent process is similar to that in FIG. 12 according to the above-described exemplary embodiment.

In step S323, the controller 304 performs a process for displaying the selectable elements “print setting” and “start printing” for each of the images in the compilation-layout display in a carousel-layout fashion. The process then proceeds to step S326. The subsequent process is similar to that in FIG. 12 according to the above-described exemplary embodiment. For example, as shown in the right part of FIG. 16, the selectable elements for each image are displayed in a carousel-layout fashion together with the image. In the example shown in FIG. 16, the selectable elements “print setting” and “start printing” for each of the images X to Z are displayed in a carousel-layout fashion. Moreover, since all of the three images X to Z are displayed in the example shown in FIG. 16, there is no horizontal scroll bar in FIG. 16. If there are three or more selectable elements, a horizontal scroll bar is displayed in FIG. 16. Alternatively, if two selectable elements are not simultaneously displayable on the screen, the non-displayed image is displayed by using a scroll bar.

As an alternative to the above exemplary embodiments in which the chat room server 20 and the chatbot server 30 are described as being separate apparatuses, for example, the chat room server 20 and the chatbot server 30 may be realized as a single apparatus. As another alternative, one or some of the functions of the chat room server 20 or the chatbot server 30 may be realized by another server.

The process performed in the chatbot server 30 according to each of the above exemplary embodiments may be a process performed by software, a process performed by hardware, or a process performed by a combination of software and hardware. Furthermore, the process performed in the chatbot server 30 may be distributed by being stored as a program in a storage medium.

The program for causing the chatbot server 30 to operate may be provided via a computer-readable storage medium, such as a universal-serial-bus (USB) memory, a flexible disk, or a compact disc read-only memory (CD-ROM), or may be provided online via a network, such as the Internet. In this case, the program stored in the computer-readable storage medium is normally forwarded to and stored in a memory or a storage unit. Moreover, for example, this program may be provided as a single application software program or may be incorporated as one of the functions of the chatbot server 30 in software of each apparatus thereof.

The present disclosure is not limited to the above description, and various modifications are permissible so long as they do not depart from the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A control apparatus comprising:
a receiving unit that receives an execution command for a predetermined process in a service, the service displaying a post posted by a user in a chronological order in a predetermined direction and being usable for commanding execution of the process; and
a controller that performs control to perform carousel-layout display such that, if the post corresponding to the execution command for the process received by the receiving unit includes a plurality of posts, the plurality of posts and command information related to the execution command for the process corresponding to the plurality of posts are displayed in the service in a slidably-operable manner in a direction intersecting the predetermined direction.

2. The control apparatus according to claim 1,
wherein the controller performs the control to perform the carousel-layout display such that, if the receiving unit receives the execution command for the process corresponding to a post associated with a predetermined group, a plurality of posts associated with the group and the command information are displayed in a carousel-layout fashion in the service.

3. The control apparatus according to claim 2,
wherein the controller performs the control to perform the carousel-layout display such that, if the receiving unit receives the execution command for the process corresponding to a post within a group chat shared by a plurality of predetermined users as the post associated with the group, a plurality of posts within the group chat and the command information are displayed in the carousel-layout fashion in the service.

4. The control apparatus according to claim 2,
wherein the controller performs the control to perform the carousel-layout display such that, if the receiving unit receives the execution command for the process corresponding to a post associated with information about each user as the post associated with the group, marker information indicating each piece of information about each user and the command information are displayed in the carousel-layout fashion in the service.

5. The control apparatus according to claim 3,
wherein the controller performs the control to perform the carousel-layout display such that, if the receiving unit receives the execution command for the process corresponding to a post associated with information about each user as the post associated with the group, marker information indicating each piece of information about each user and the command information are displayed in the carousel-layout fashion in the service.

6. The control apparatus according to claim 1,
wherein the controller performs the control to perform the carousel-layout display such that, if a post posted in the service and not having undergone the process includes a plurality of posts as the plurality of posts corresponding to the execution command for the process received by the receiving unit, the plurality of posts posted in the service and not having undergone the process and the command information are displayed in the carousel-layout fashion in the service.

7. The control apparatus according to claim 6,
wherein the controller performs the control to perform the carousel-layout display such that, if the post posted in the service and not having undergone the process includes a plurality of posts after the process received by the receiving unit is executed, the plurality of posts posted in the service and not having undergone the process and the command information are displayed in the carousel-layout fashion in the service.

8. The control apparatus according to claim 6,
wherein the controller performs the control to perform the carousel-layout display such that, in a state where the post not having undergone the process exists, if a post corresponding to an execution command for a subsequent process is posted in the service and the receiving unit receives the execution command for the subsequent process as a case where the post corresponding to the execution command for the process received by the receiving unit includes a plurality of posts, the post corresponding to the subsequent process, the post not having undergone the process, and the command information corresponding to each of the post corresponding to the subsequent process and the post not having undergone the process are displayed in the carousel-layout fashion in the service.

9. The control apparatus according to claim 8,
wherein the controller performs further control to delete a past post included in the carousel-layout display when the controller performs the carousel-layout display.

10. The control apparatus according to claim 1,
wherein the controller performs the control to perform the carousel-layout display such that, if the post corresponding to the execution command for the process received by the receiving unit includes a plurality of posts, the plurality of posts and the command information corresponding to the plurality of posts are collectively displayed as predetermined compilation information in the service before the plurality of posts and the command information are displayed in a carousel-layout fashion, and if an operation is performed on the compilation information, the plurality of posts and the command information compiled in the compilation information are displayed in the carousel-layout fashion in the service.

11. A control system comprising:
the control apparatus according to claim 1;
a providing apparatus that provides the service; and
a terminal apparatus that is used by a user for posting a post in the service.

12. A control system comprising:
a providing unit that provides a service displaying a post posted by a user in a chronological order in a predetermined direction and usable for commanding execution of a predetermined process;
a receiving unit that receives an execution command for the process in the service; and
a controller that performs control to perform carousel-layout display such that, if a post corresponding to the execution command for the process received by the receiving unit includes a plurality of posts, the plurality of posts and command information related to the execution command for the process corresponding to the plurality of posts are displayed in the service in a slidably-operable manner in a direction intersecting the predetermined direction.

13. A non-transitory computer readable medium storing a program causing a computer to execute a control process, the control process comprising:
receiving an execution command for a predetermined process in a service that displays a post posted by a user in a chronological order in a predetermined direction and that is usable for commanding execution of the process; and
performing control to perform carousel-layout display such that, if a post corresponding to the received execution command for the process includes a plurality of posts, the plurality of posts and command information related to the execution command for the process corresponding to the plurality of posts are displayed in the service in a slidably-operable manner in a direction intersecting the predetermined direction.
